(19) United States
(12) Patent Application Publication
(10) Pub. No.: US 2008/0126162 A1
(43) Pub. Date: May 29, 2008

(54) INTEGRATED ACTIVITY LOGGING AND INCIDENT REPORTING

(76) Inventors: Keith W. Angus, Maidstone (GB); Scott D. Hicks, Underhill Center, VT (US); James A. Martin, Endicott, NY (US); Jeffrey E. Prince, Bloomfield Hills, MI (US); Jonathan J. Read-Bone, Sandbach (GB)

Correspondence Address: HOFFMAN, WARNICK & D'ALESSANDRO LLC, 75 STATE ST, 14TH FLOOR, ALBANY, NY, 12207, US

(21) Appl. No.: 11/563,816

(22) Filed: Nov. 28, 2006

(51) Int. Cl. G05B 19/418; G06F 9/46

(52) U.S. Cl. 705/8

(57) ABSTRACT

A solution for improving the logging, tracking, and/or reporting of activities and incidents of a project, and more particularly, to an integrated activity logging and incident reporting system is provided. A method may include: providing an on-line electronic database, wherein the database includes a plurality of activities related to the project and at least one incident, wherein the at least one incident is related to at least one activity; providing an activity log from the database; and providing an incident report from the database, wherein the incident report is integrated to the activity log, and wherein access to at least one of the activity log and the incident report is selectable. In an embodiment, the on-line electronic database communicates with an enterprise migration manager (EMM) database for an information technology (IT) transformation project.

### FIELD OF THE INVENTION

The invention relates generally to project management and improving the logging, tracking, and/or reporting of activities and incidents of a project, and more particularly, provides for integrated activity logging and incident reporting.

### BACKGROUND OF THE INVENTION

A project that entails multiple sites, multiple team members, and/or multiple activities, and the project management thereof, are complicated. The management of activities, so called “key” activities, and/or, milestones is further exacerbated upon the need to disseminate accurate information to these multiple team members over multiple sites.

Further complicating a project is the common occurrence during the project, unanticipated or otherwise, of additional incidents, issues, and/or problems. Incidents often include an activity not being completed as originally scheduled. Current methods of logging, tracking, and/or reporting incidents include, for example, writing the incident on a “white board” in a central command center; entering the incident into a spreadsheet; creating a word processing document that lists incidents; and/or entering the incident into a table or list in an electronic mail (e-mail) document. With all these methods, the document (email, spreadsheet, word processing document, and/or white board writings) must be periodically transmitted to recipients or, for example, posted in an electronic teamroom or website for subsequent downloading.

These methodologies unfortunately require continual transmission and receipt of e-mails, or posting and downloading of file attachments from a teamroom or a website. The access control to this information is essentially “binary” in that team members either have full access to all the information, or no access to any information. Further, there is no automatic linkage, or integration, of incident information to other project information such as schedule; work orders; physical site information; technical information including network, hardware, software, or telecommunications data; personnel or skills information; e-mail addresses or telephone numbers of project team members, and/or the like.

Post-incident methodologies are lacking as well. There is no automated way to store and then retrieve details of the incidents and issues at a later date, based on any type of intelligent selectable criteria. Typically, documents must be retrieved in their entirety. This hinders analysis of the activities, work patterns, issues, and solutions based on the lack of an adequate historical record.

In any event, current methodologies for logging, tracking, and/or reporting activities and/or incidents are inadequate. In view of the foregoing, a need exists to overcome one or more of the deficiencies in the related art.

### BRIEF SUMMARY OF THE INVENTION

Aspects of the present invention include a solution for improving the logging, tracking, and/or reporting of activities and incidents of a project, and more particularly, to an integrated activity logging and incident reporting system.

A first aspect of the present invention is directed to a method of managing a project, wherein the project includes a plurality of activities, a schedule, and a plurality of team members, the method comprising: providing an on-line electronic database, wherein the database includes a plurality of activities related to the project and at least one incident, wherein the at least one incident is related to at least one activity; providing an activity log from the database; and providing an incident report from the database, wherein the incident report is integrated to the activity log, and wherein access to at least one of the activity log and the incident report is selectable.

A second aspect of the present invention is directed to a system for managing a project, wherein the project includes a plurality of activities, a schedule, and a plurality of team members, the system comprising: an on-line electronic database, wherein the database includes a plurality of activities related to the project and at least one incident, wherein the at least one incident is related to at least one activity; an activity log system for generating an activity log; and an incident reporting system for generating an incident report, wherein the incident reporting is integrated to the activity log, and wherein access to at least one of the activity log and the incident report is selectable.

A third aspect of the present invention is directed to a computer program stored on a computer-readable medium, which when executed, enables a computer system to manage a project, wherein the project includes a plurality of activities, a schedule, and a plurality of team members, the computer program comprising program code for enabling the computer system to: provide an on-line electronic database, wherein the database includes a plurality of activities related to the project and at least one incident, wherein the at least one incident is related to at least one activity; provide an activity log from the database; and provide an incident report from the database, wherein the incident report is integrated to the activity log, and wherein access to at least one of the activity log and the incident report is selectable.

A fourth aspect of the present invention is directed to a method for deploying a system for managing a project, wherein the project includes a plurality of activities, a schedule, and a plurality of team members, the method comprising: providing a computer infrastructure being operable to: provide an on-line electronic database, wherein the database includes a plurality of activities related to the project and at least one incident, wherein the at least one incident is related to at least one activity; provide an activity log from the database; and provide an incident report from the database, wherein the incident report is integrated to the activity log, and wherein access to at least one of the activity log and the incident report is selectable.

A fifth aspect of the invention provides computer software embodied in a propagated signal for managing a project, wherein the project includes a plurality of activities, a schedule, and a plurality of team members, the computer software comprising instructions to cause a computer system to perform the following: provide an on-line electronic database, wherein the database includes a plurality of activities related to the project and at least one incident, wherein the at least one incident is related to at least one activity; provide an activity log from the database; and provide an incident report from the database, wherein the incident report is integrated to the activity log, and wherein access to at least one of the activity log and the incident report is selectable.

A sixth aspect of the present invention is directed to a business method for managing a project, the business method comprising: managing a computer system that performs the process described herein; and receiving payment based on the managing.

The illustrative aspects of the present invention are designed to solve the problems herein described and other problems not discussed.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 depicts a schematic flow diagram of an illustrative process in accordance with an embodiment of the present invention.

FIG. 2 depicts an exemplary transformation activity log in accordance with an embodiment of the present invention.

FIG. 3 depicts an exemplary transformation activity log entry in accordance with an embodiment of the present invention.

FIG. 4 depicts an exemplary selectable drop down menu for use with the log entry in FIG. 3 in accordance with an embodiment of the present invention.

FIG. 5 depicts an exemplary incident report entry in accordance with an embodiment of the present invention.

FIG. 6 depicts an exemplary selectable drop down menu for use with the incident report entry in FIG. 5 in accordance with an embodiment of the present invention.

FIG. 7 depicts an exemplary incident report in accordance with an embodiment of the present invention.

FIG. 8 depicts an exemplary incident report employing a full searchable text feature in accordance with an embodiment of the present invention.

FIG. 9 depicts an exemplary transformation management summary in accordance with an embodiment of the present invention.

FIG. 10 depicts an illustrative system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Aspects of the present invention include improvements in logging, tracking and/or reporting activities and incidents, by employing an integrated transformation activity logging and incident reporting system.

Incidents as the term is used herein can include a mistake, a problem, an unexplained event, an error, a predecessor and/or concurrent activity(ies) not being completed. An incident can be caused by virtually any source, either intraproject, interproject, and/or ultra project. By example only, an incident may be a device (e.g., equipment, server, etc.) that did not arrive on time. An incident could be a person who is scheduled to do a particular task(s), but did not arrive on time. Alternatively, an incident could be someone did a task, but made a mistake (e.g., set up equipment incorrectly). An incident may be a piece of hardware that is defective. A telecommunication circuit that is installed, but not operational would be another example of an incident.

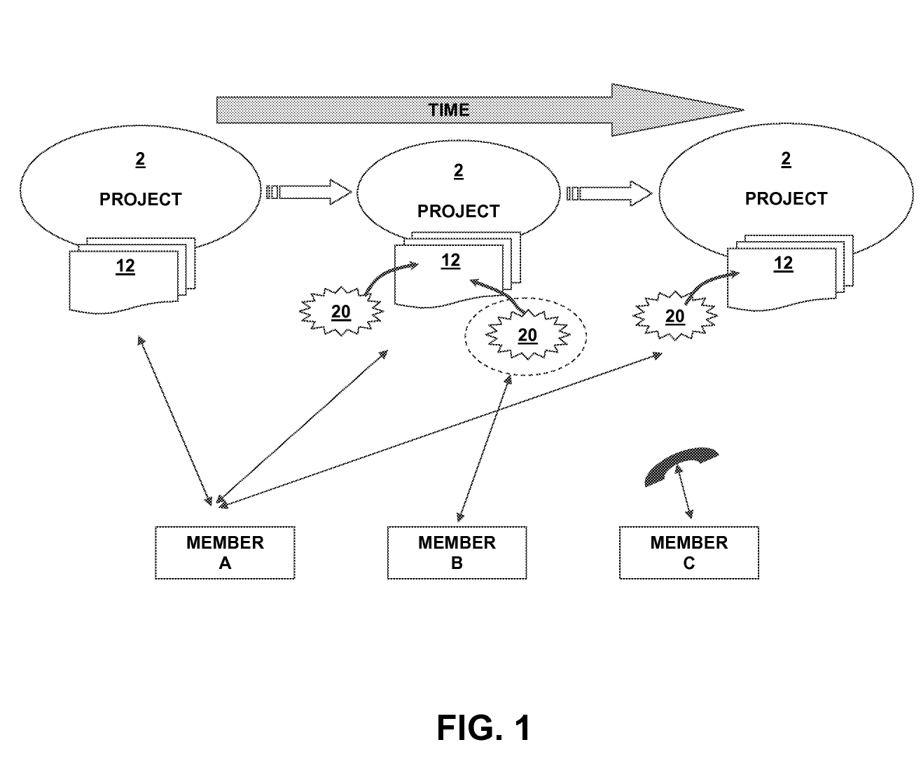

In any event, a schematic flow diagram of an illustrative process in accordance with embodiment(s) of the present invention is depicted in FIG. 1. A project 2, typically includes a plurality of activities 12, one or more members A-C, and/or one or more sites (not shown). The project 2 (e.g., a schedule), changes over time. Often, at least one incident 20 (as defined herein) occurs during the course of the project 2. The incident 20 is related to at least one activity 12. As depicted, incidents 20 may be added and, upon their successful resolution, deleted during the progress of the project 2 over time. Although FIG. 1 shows one configuration of the various aspects of a project 2, under the present invention the quantity and type of aspects may vary from that shown. For example, the members A-C of the project team may range from one, to near infinite. The quantity of activities 12 and incidents 20 also may range from one to, near infinite. As can other aspects, including, subproject(s), site(s), and/or the like.

In any event, as shown in FIG. 1, aspects of the present invention allow for a selectable access to the activities 12 and/or incidents 20 of a project 2 by various members of the project 2. For example, member “A” has access to all information (e.g., all activities 12 and incidents 20) on the project 2 over time. Contrastingly, member “B” has limited, or selected, access. In this case, member “B” has access to only a single incident 20 (as shown by dotted line). Finally, member “C” has no access to activities 12 and incidents 20 (as depicted by heavy black horseshoe). The adjustment of access, based on the member, activity 12, incident 20, and/or other aspects (e.g., subproject, site, etc.) is described in more detail herein.

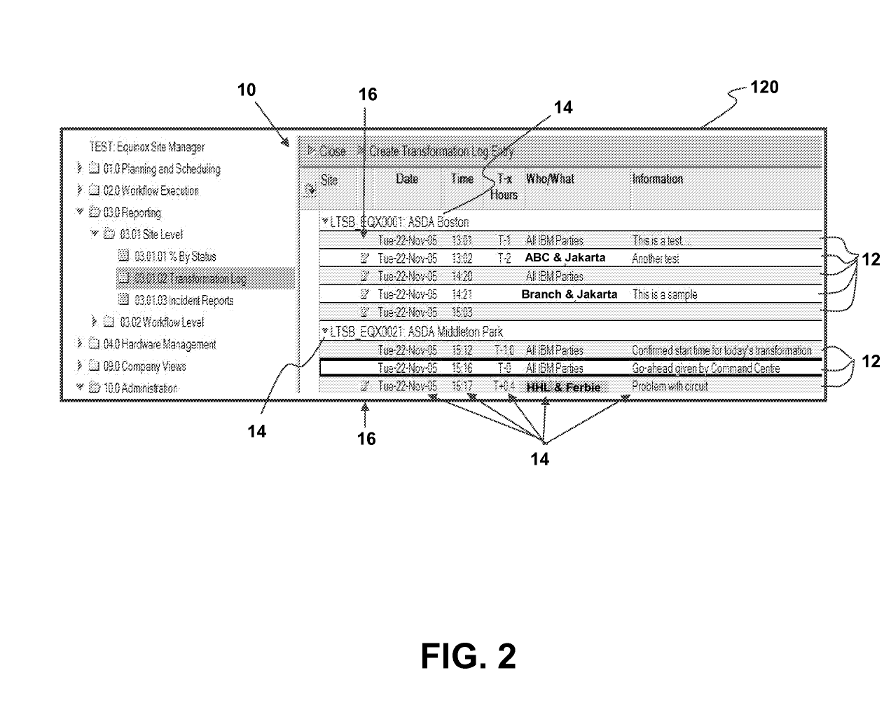

FIG. 2 through FIG. 10 show illustrative embodiment(s) for managing a project 2 (FIG. 1), wherein the project 2 includes a plurality of activities 12, a schedule, and plurality of team members. FIG. 2, for example, shows an embodiment of an activity (e.g., transformation activity) log 10 depicted on a graphical user interface (GUI)

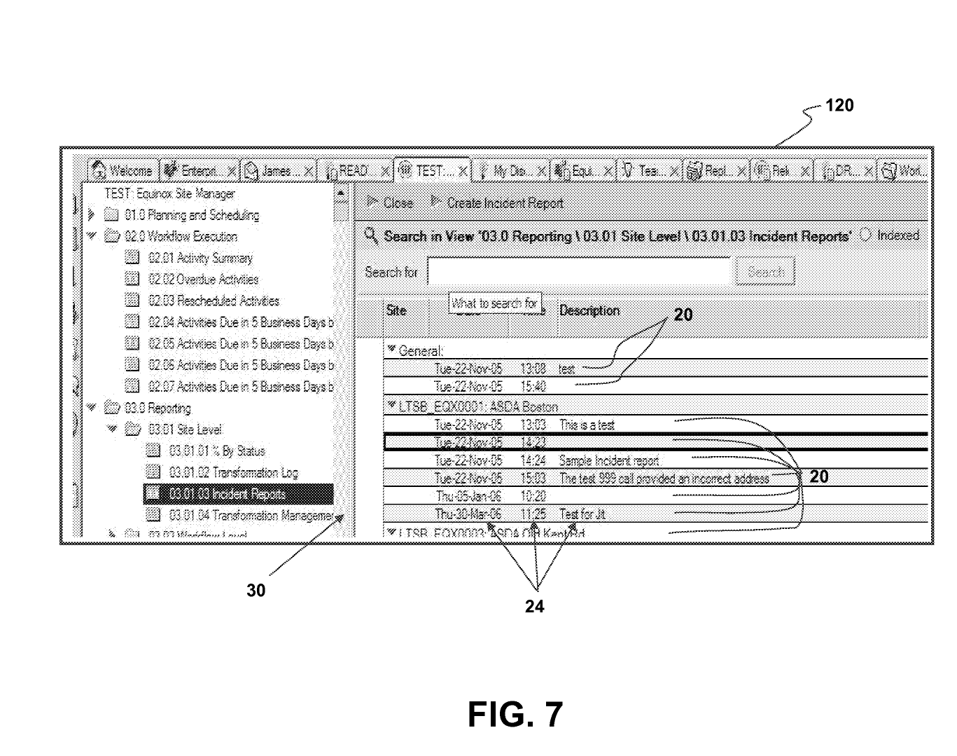

120. Although aspects of the present invention are shown in several embodiments on the GUI 120, the invention is not limited to use of the GUI 120. Clearly, other embodiments are included within the scope of aspects of the invention including, for example, providing the transformation activity log 10, and/or an incident report 30 (see e.g., FIG. 7) as a printed report, an audio communication, and/or any tangible medium of expression.

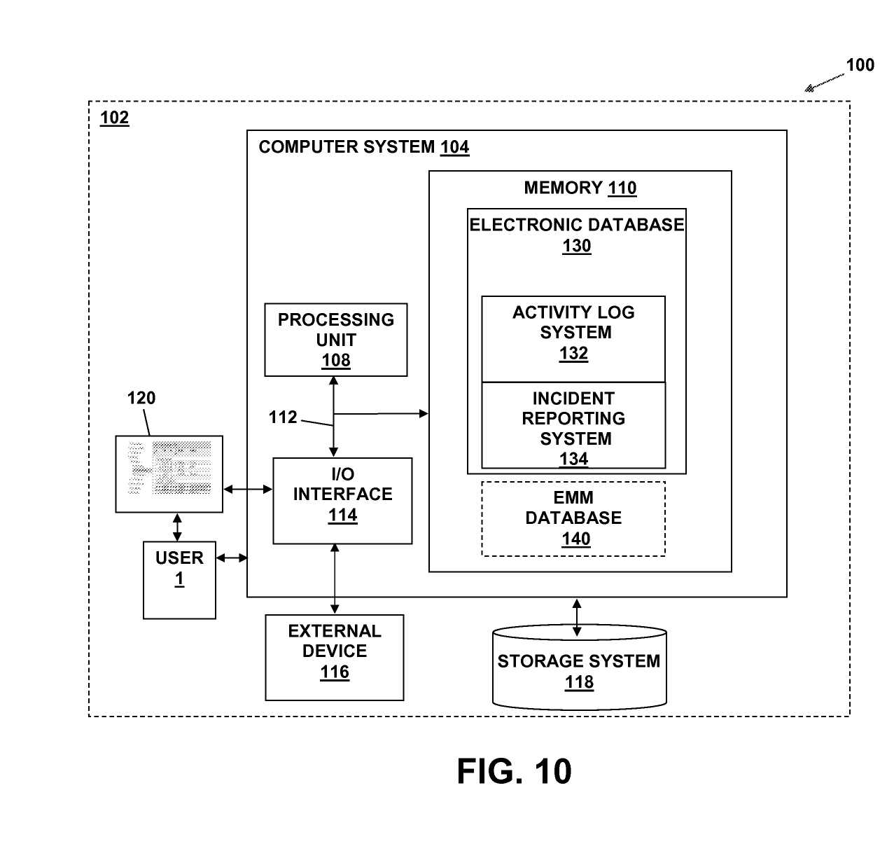

In any event, as FIG. 2 shows, the activity log 10 which includes activities 12 and various activities aspects 14 that allow the user 1 (FIG. 10) to log, track, and/or report on activities 12 of a project 2 (FIG. 1). Activity aspects 14 may include a date, a time, a number of hours (T−x) until an activity 12 is scheduled to occur, a who/what members, other information related to the activity 12, and/or the like. As depicted, the activities 12 are sorted by, in this case, sites. For example, five (5) activities 12 are listed under site “LTSB_EQX0001: ASDA Boston”, while three (3) activities 12 are listed under site “LTSB_EQX0021: ASDA Middleton Park”. Other aspects 14 may be indicated on the log 10.

The incident report 30 (FIG. 7) and any incidents 20 (FIG. 7) therein is integrated with the activity log 10. Thus, a user 1 (FIG. 10) is able to readily see if an incident 20 is associated with a particular activity 12. FIG. 2 shows an incident indicia 16, in this case an icon, so that the activity log 10 includes, at the least, indication that a particular activity 12 has an incident 20 associated therewith. For example, of the five activities 12 shown under site “LTSB_EQX0001: ASDA Boston”, the last four activities 12 have an incident 20 associated therewith (i.e., incident indicia 16 icon is shown on four of five activities 12). Similarly, of the three activities 12 shown under site “LTSB_EQX0021: ASDA Middleton Park”, only the last activity 12 has an incident 20 associated therewith (i.e., incident indicia 16 icon is shown on the last activity 12).

While FIG. 1 shows a generic project 2, activities 12, members, and incidents 20 in accordance with aspects of the present invention, FIGS. 2 through 10 depict embodiments that may employ communication and/or interaction with an Enterprise Migration Manager (EMM), and/or any implementation thereof, such as Equinox Site Manager, both manufactured by International Business Machines Corporation. These views are illustrative only and are not limiting. Note that throughout these various figures, for illustrative purposes a project 2 that entails an information technology (IT) transformation project 2 is shown.

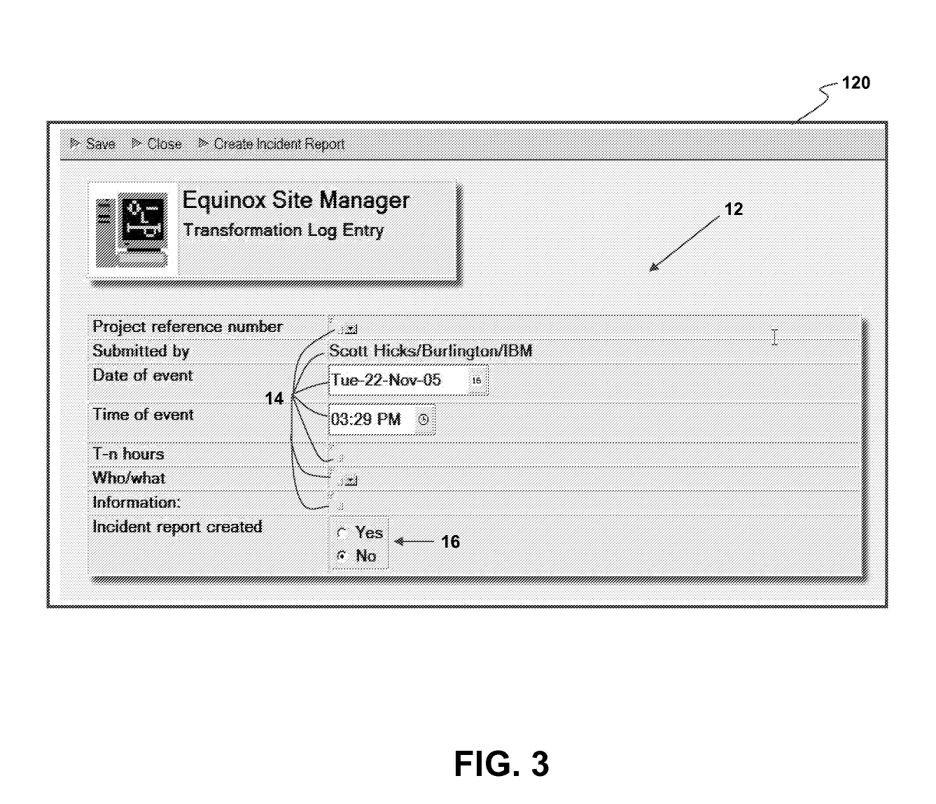

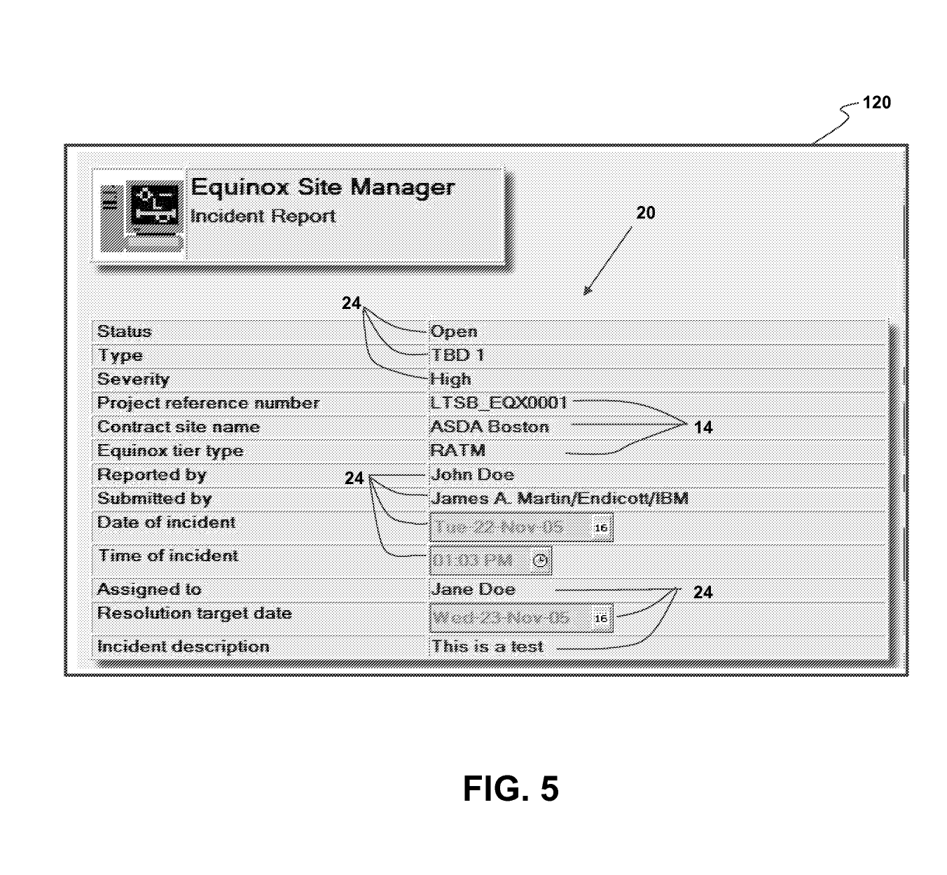

Turning to additional figures, FIG. 3 depicts a GUI 120 that includes an exemplary transformation activity log entry, depicted as a single activity 12. The GUI 120 allows the user 1 (FIG. 10) to view, enter, and/or edit, various aspects 14 of information related to an activity 12 including, for example, project reference number, submitted by, data of activity (or event), time of activity (or event), time in hours (t-n) until activity, who/what, additional information, and/or other aspects 14 not shown. These aspects 14 may be viewed, entered, and/or edited in the GUI 120 shown in FIG. 3 are the same aspects 14 depicted in the GUI 120 in FIG. 2. The incident indicia 16 at the bottom of the transformation log entry allows the user 1 to create an incident 20 (FIG. 5) that is related to and integrated with a particular activity 12. By toggling the incident indicia 16 to “yes”, an incident 20 is created.

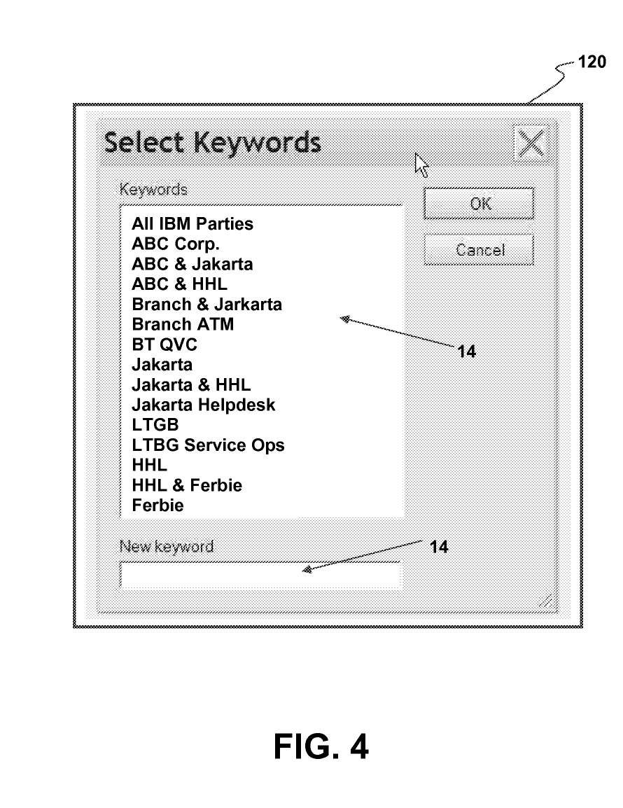

FIG. 4 depicts a GUI 120 that includes a drop down menu listing all available values for one of the aforementioned activity aspects 14 (e.g., “who/what”). Thus, when logging an activity 12 on the GUI 120 in FIG. 3, a user 1 (FIG. 10) can select a particular value for the aspect 14 from the listed available values on the drop down menu in FIG. 4 for the particular activity 12 being entered and/or edited. Additionally, the value entered in the “who/what” aspect 14 may be employed for various search, sort, and/or access criteria.

FIG. 5 depicts a GUI 120 that includes an exemplary incident report entry screen illustrating a single incident 20. The GUI 120 allows the user 1 (FIG. 10) to view, enter, and/or edit an incident 20 and various aspects 24 of information related to the incident 20 including, for example, status, type, severity, reported by, submitted by, date of incident, time of incident, assigned to, resolution target date, incident description, and/or other aspects 24 not shown. These various aspects 24 are alternatively shown in incident report 30 in the GUI 120 depicted in FIG. 7.

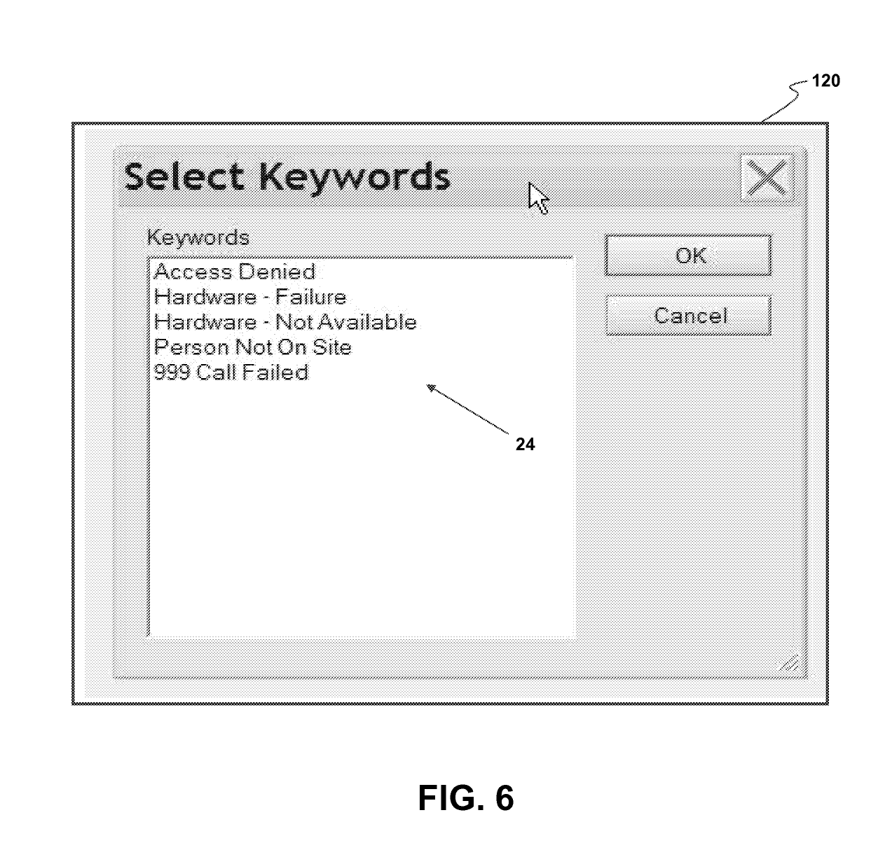

Similar to the drop down menu illustrated in FIG. 4, FIG. 6 depicts a GUI 120 that includes a drop down menu listing available values for incident aspects 24. In this case, the incident aspect 24 listed is the “type” involved with the incident 20. Thus, when, for example, logging an incident 20 on the GUI 120 in FIG. 5, a user 1 can select a particular value for the aspect 24 of the type of incident 20 entered. The “type” aspect 24 may be additionally employed for various search, sort, and/or access criteria.

FIG. 7 depicts an illustrative incident report 30, which includes incidents 20 and various incident aspects 24. Incident report 30 allows the user 1 (FIG. 10) to log, track, and/or report on incidents 20 of a project 2 (FIG. 1). Incident aspects 24 may include a date, a time, a description, a site, other information related to the incident 20, and/or the like. As depicted, the incidents 20 are sorted by, in this case, the corresponding sites. For example, six (6) incidents 20 are listed under site “LTSB_EQX0001: ASDA Boston”, while two (2) incidents 20 are listed under site “General”. Other aspects 24 may be indicated on the report 30.

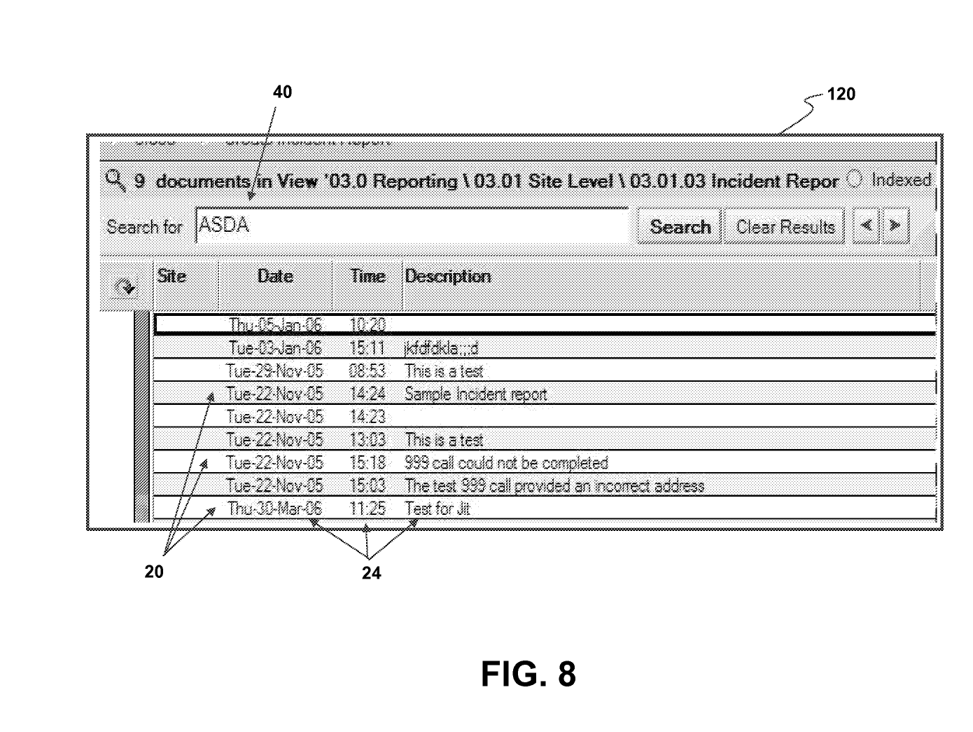

FIG. 8 depicts a GUI 120 that is employing a full text searchable feature 40 in accordance with the present invention. The full text searchable feature 40 may be employed with either the activity log 10 (FIG. 2) and/or the incident report 30 (FIG. 7). In the view shown, the incident report 30 is employing the full text searchable feature 40. In this manner, a user 1 (FIG. 10) may enter any string of text (e.g., “ASDA”) and thereby obtain any incident 20 and/or activity 12 that includes the entered string of text. As the example in FIG. 8 shows, by entering the string “ASDA” (which in the example depicted throughout, is a particular site location), the user 1 obtains on the GUI 120 all incidents 20 that include the string “ASDA” in either the incident 20 and/or aspects 12, 24 related thereof.

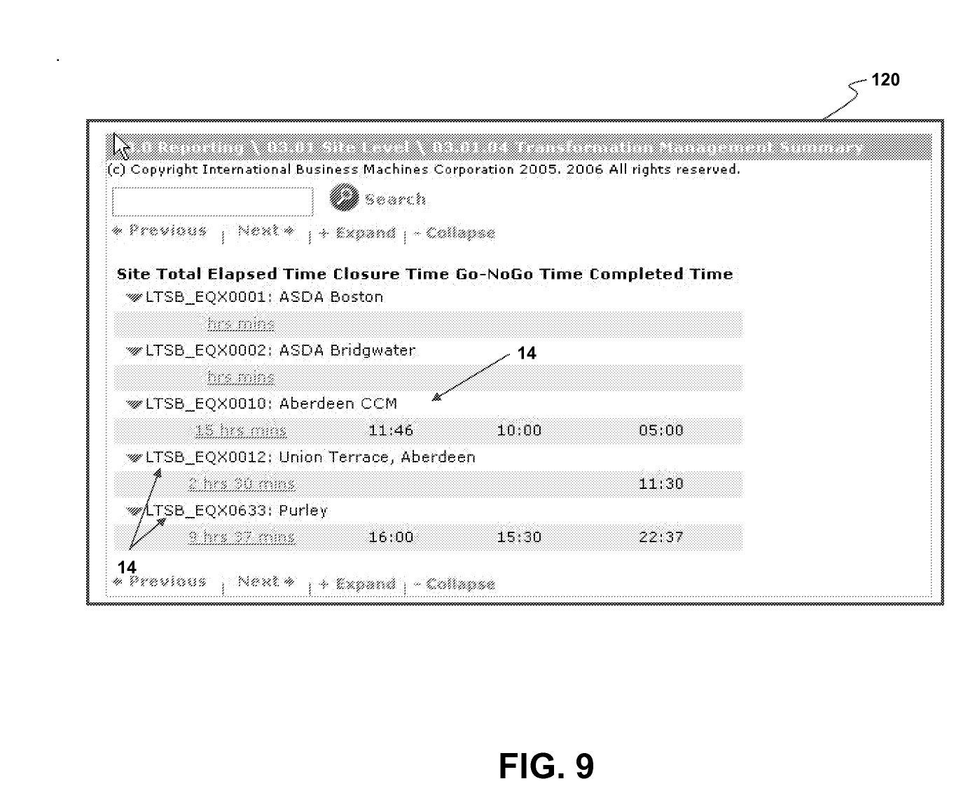

FIG. 9 depicts a GUI 120 for an exemplary transformation management summary in accordance with embodiment(s) of the present invention. The transformation management summary may show other views of various aspects 14, 24 of the activity log and/or the incident report. As shown, FIG. 9 indicates an activity aspect 14 (e.g., “T−x hours”) summarized by another activity aspect 14 (e.g., site).

FIG. 10 depicts an illustrative system 100 in accordance with embodiment(s) of the present invention. The system 100 includes a computer infrastructure 102 that can perform the process described herein. The computer infrastructure 102 is shown including a computer system 104.

The computer system 104 is shown including a processing unit 108, a memory 110, at least one input/output (I/O) interface 114, and a bus 112. Further, the computer system 104 is shown in communication with at least one external device 116 and a storage system 118. In general, the processing unit 108 executes computer program code that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device(s) 116 can comprise any device that enables a user 1 to interact with the computer system 104 (e.g., GUI 120) or any device that enables the computer system 104 to communicate with one or more other computer systems.

In accordance with an embodiment of the present invention, the program code stored in the memory 110 comprises an on-line electronic database 130, wherein the database 130 includes a plurality of activities 12 related to the project 2 and at least one incident 20. Provided as part of the database 130 is an activity log system 132 and an incident reporting system 134 that is integrated to the activity log system 132. The activity log system 132 provides for the logging of the plurality of activities 12 as discussed herein. The incident reporting system 134 provides for a reporting of incidents 20 that are related to the activities 12 as discussed herein. In this manner, a user 1 is able to discern information regarding incidents 20 while using the activity log system 132. The database 130 may further comprise a full text search system (see e.g., FIG. 8) for use with either the activity log system 132 and/or the incident reporting system 134. At least one of the systems 132, 134 has selectable access thereto. Also provided may be a project database, such as an enterprise migration manager (EMM) database 140. The operation carried out by each of these systems is described in greater detail herein.

The computer system 104 can comprise any general purpose computing article of manufacture capable of executing computer program code installed thereon (e.g., a personal computer, server, handheld device, etc.). However, it is understood that the computer system 104 and its various elements is only representative of various possible computer systems that may perform the processes of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in one embodiment, the computer infrastructure 102 comprises two or more computer systems (e.g., a server cluster) that communicate over any type of wired and/or wireless communications link, such as a network, a shared memory, or the like, to perform the processes of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

It is understood that some of the various systems shown in FIG. 10 can be implemented independently, combined, and/or stored in memory for one or more separate computer systems that communicate over a network. Further, it is understood that some of the systems and/or functionality may not be implemented, or additional systems and/or functionality may be included as part of the system 100.

It is understood that the invention further provides various alternative embodiments. For example, in one embodiment, the invention provides a computer-readable medium that includes computer program code to enable a computer infrastructure to carry out and/or implement the process of the present invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process of the invention on a subscription, advertising, and/or fee basis. A service provider can create, maintain, support, etc., a computer infrastructure, such as the computer infrastructure 102, that performs the process of the invention for one or more customers. In return, the service provider can receive payment from the customer(s) under a subscription and/or fee agreement and/or the service provider can receive payment from the sale of advertising space to one or more third parties.

In still another embodiment, a computer infrastructure, such as the computer infrastructure 102, can be obtained (e.g., created, maintained, having made available to, etc.) and one or more systems for performing the process of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method of managing a project, wherein the project includes a plurality of activities, a schedule, and a plurality of team members, the method comprising:
providing an on-line electronic database, wherein the database includes a plurality of activities related to the project and at least one incident, wherein the at least one incident is related to at least one activity;
providing an activity log from the database; and
providing an incident report from the database, wherein the incident report is integrated to the activity log, and wherein access to at least one of the activity log and the incident report is selectable.

2. The method of claim 1, further comprising:
providing a communication link between the database and an enterprise migration manager (EMM) database.

3. The method of claim 1, further comprising:
providing full text search capability for at least one of the activity log and the incident report.

4. The method of claim 1, further comprising:
displaying at least one of the activity log and the incident report on a graphical user interface (GUI).

5. The method of claim 1, wherein the project is an information technology (IT) migration project.

6. The method of claim 1, wherein the access includes a hierarchy of access levels configured to each of the plurality of team members.

7. The method of claim 1, wherein the incident is an activity not being completed as originally scheduled.

8. The method of claim 1, wherein the activity log includes an indicia of the incident.

9. A system for managing a project, wherein the project includes a plurality of activities, a schedule, and a plurality of team members, the system comprising:
an on-line electronic database, wherein the database includes a plurality of activities related to the project and at least one incident, wherein the at least one incident is related to at least one activity;
an activity log system for generating an activity log; and
an incident reporting system for generating an incident report, wherein the incident reporting is integrated to the activity log, and wherein access to at least one of the activity log and the incident report is selectable.

10. The system of claim 9, further comprising a communication link between the database and an enterprise migration manager (EMM) database.

11. The system of claim 9, further comprising:
a full text search system for at least one of the activity log and the incident report.

12. The system of claim 9, further comprising:
a system for displaying at least one of the activity log and the incident report on a graphical user interface (GUI).

13. The system of claim 9, wherein the project is an information technology (IT) migration project.

14. The system of claim 9, wherein the access includes a hierarchy of access levels configured to each of the plurality of team members.

15. The system of claim 9, wherein the incident is an activity not being completed as originally scheduled.

16. The system of claim 9, wherein the activity log provides an indicia of the incident.

17. A computer program stored on a computer-readable medium, which when executed, enables a computer system to manage a project, wherein the project includes a plurality of activities, a schedule, and a plurality of team members, the computer program comprising program code for enabling the computer system to:
provide an on-line electronic database, wherein the database includes a plurality of activities related to the project and at least one incident, wherein the at least one incident is related to at least one activity;
provide an activity log from the database; and
provide an incident report from the database, wherein the incident report is integrated to the activity log, and wherein access to at least one of the activity log and the incident report is selectable.

18. The computer program of claim 17, further comprising program code for enabling the computer system to:
provide a communication link between the database and an enterprise migration manager (EMM) datbase.

19. The computer program of claim 17, further comprising program code for enabling the computer system to:
display at least one of the activity log and the incident report on a graphical user interface (GUI).

20. A method for deploying a system for managing a project, wherein the project includes a plurality of activities, a schedule, and a plurality of team members, the method comprising:
providing a computer infrastructure being operable to:
provide an on-line electronic database, wherein the database includes a plurality of activities related to the project and at least one incident, wherein the at least one incident is related to at least one activity;
provide an activity log from the database; and
provide an incident report from the database, wherein the incident report is integrated to the activity log, and wherein access to at least one of the activity log and the incident report is selectable.
